(19) United States
(12) Patent Application Publication
(10) Pub. No.: US 2011/0209677 A1
(43) Pub. Date: Sep. 1, 2011

(54) HYDRAULIC ASSEMBLY AND HYDRAULIC VALVE FOR FORMING SAID ASSEMBLY

(75) Inventors: Thomas Krämer, Rothenbach (DE); Marco Meisborn, Hochstadt a.d. Aisch (DE); Steffen Alvermann, Essen (DE); Johannes Weninger, Gerhardshofen (DE); Henrik Meinel, Herzogenaurach (DE)

(73) Assignee: SCHAEFFLER KG, Herzogenaurach (DE)

(21) Appl. No.: 12/637,059

(22) Filed: Dec. 14, 2009

(30) Foreign Application Priority Data
Dec. 13, 2008 (DE) 102008062166.8

(51) Int. Cl. F01L 9/02; F16K 27/00

(52) U.S. Cl. 123/90.12; 251/366

(57) ABSTRACT

A hydraulic assembly (1), particularly for an electrohydraulic valve control of an internal combustion engine, and a hydraulic valve (2) for forming such an assembly are provided. The assembly includes a hydraulic valve with a valve housing (4) and a valve carrier (3) with a valve receiver (5) in which the valve housing is received. The valve housing has a first circumferential groove (9) and a second circumferential groove (10), with the grooves (9 and 10) being defined respectively by groove walls (13, 15 and 14, 16) and extending on two sides of a hydraulic connection (6) which extends through a peripheral wall of the valve housing (4). A bead (11, 12) formed by a plastic deformation of material of the valve carrier being received in each of the two said grooves (9, 10), so that the groove walls and the beads not only fix the valve housing in the valve receiver by positive engagement but also cooperate with each other to hydraulically seal the valve housing. Outer groove walls of the circumferential grooves are oriented towards each other and extend parallel to each other and perpendicularly to the receiving direction of the valve housing.

### CROSS-REFERENCE TO RELATED APPLICATIONS

This application claims the benefit of German Patent application DE 10 2008 062 166.8, filed Dec. 13, 2008, which is incorporated herein by reference as if fully set forth.

### BACKGROUND

The invention concerns a hydraulic assembly, particularly for an electrohydraulic valve control of an internal combustion engine, and a hydraulic valve for forming such an assembly. This assembly comprises a hydraulic valve comprising a valve housing and a valve carrier with a valve receiver in which the valve housing is received. At least in the region of the valve receiver, the valve carrier has a distinctly lower material strength than the valve housing in which are disposed a first and a second circumferential groove defined respectively by groove walls and extending on both sides of a hydraulic connection which extends through a peripheral wall of the valve housing and is in hydraulic communication with a hydraulic channel which is arranged in the valve carrier and opens into the valve receiver, a bead formed by a plastic deformation of material of the valve carrier being received in each of the first and the second circumferential grooves, so that, in a receiving direction of the valve housing, the groove walls and the beads not only fix the valve housing in the valve receiver by positive engagement but also cooperate with each other to hydraulically seal the valve housing.

An assembly of the above-noted type is disclosed in the document DE 44 14 583 A1. The fixing of the valve housing in the valve receiver by positive engagement is realized through a calking method, designated hereinafter as clinched connection, which takes place automatically during assembly of the hydraulic valve and the valve carrier. For this purpose, the peripheries of the valve housing and the valve receiver comprise in the region of the circumferential grooves, stepped diameters that are matched to each other such that the material of the valve carrier displaced by the harder material of valve housing, which acts as a calking die, flows into the circumferential grooves and gets compressed to form beads within these grooves. To improve the material flow, the cited prior art and also common practice proposes to configure the circumferential grooves in the form of chamfered grooves, i.e. with one inclined groove wall on the smaller diameter-side in assembling direction.

However, this structural design can prove to be problematic with respect to the hydraulic sealing function of the beads pressed into the circumferential grooves if the different materials of the valve carrier and valve housing have considerably differing thermal expansion coefficients and the assembly is exposed to large temperature variations in operation. This is particularly true if, on the one hand, the known material pairing for the clinched connection, viz., a valve carrier made of an aluminum material and a valve housing made of a steel material, is used and, on the other hand, the assembly is a part of the above-noted electrohydraulic valve control of an internal combustion engine where its operation has to be guaranteed for a temperature range of −30° C. to 150° C., which is typically specified for valve controls in which sealing is required at peak hydraulic medium pressures of about 150 bars. The reason for this is that, in the low temperature range, the periphery of the valve receiver contracts distinctly more strongly than the periphery of the valve housing, so that, in this case, excellent sealing contacts are achieved both inside and outside of the circumferential grooves, but conversely, in the high temperature range, a circumferential gap can be formed between the comparatively strongly expanding valve receiver and the valve housing. The sealing effect of the clinched connection can then only be maintained through the relative expansion of the valve receiver in receiving direction of the valve housing in that the beads press against the two outer, oppositely oriented groove walls of the circumferential grooves.

As explained more clearly below with reference to the appended figures, the maximal achievable pressing force, however, depends substantially on the configuration of the chamfered circumferential grooves. Specifically, in the region of the groove wall inclinations that favor material flow, there exists a risk of inadequate normal forces and, consequently, also of an inadequate sealing effect between bead and groove wall.

### SUMMARY

It is therefore an object of the invention to improve a hydraulic assembly of the above-noted type and a hydraulic valve for forming such an assembly, so that the aforesaid drawbacks are overcome with simple means. The clinched connection should produce an adequate sealing effect in the entire operational temperature and pressure ranges of the assembly in order to prevent leakage of hydraulic medium in the receiving direction of the valve house, at least substantially.

This and other objects and advantages of the invention will become obvious from the following detailed description.

According to the invention, the circumferential grooves comprise outer groove walls that are oriented towards each other and extend parallel to each other and perpendicularly to the receiving direction of the valve housing. By outer groove walls are to be understood one groove wall of the first circumferential groove and one groove wall of the second circumferential groove which are spaced furthest away from each other while being oriented towards each other.

In other words, the invention is based on a conscious reversal of the hitherto usual design of the circumferential grooves all of which have a chamfered groove configuration in the assembly direction, in order to assure an adequate sealing effect of the clinched connection even in the upper operational temperature range of the assembly. The considerably enhanced sealing action at high temperatures is achieved by the fact that the beads, which distance themselves more strongly from each other than the circumferential grooves in the receiving direction of the valve housing, apply high normal forces on the two outer groove walls of the circumferential grooves which, together with the concomitant, correspondingly higher contact pressures, produce a strong sealing effect.

According to a further development of the invention, the oppositely oriented inner groove walls of the circumferential grooves likewise extend parallel to each other and perpendicularly to the receiving direction of the valve housing. Analogously to the above explanation, by inner groove walls are to be understood the other groove wall of the first circumferential groove and the other groove wall of the second circumferential groove which are situated nearest to each other while facing away from each other.

While the configuration of the groove bottom which connects the groove walls to each other, i.e. the surface of the circumferential groove which is directed in the circumferential direction of the valve housing, can be at least substantially freely chosen and can have, for example, a circular arc shape, the circumferential grooves must have a substantially rectangular cross-section.

In connection with this, suitable tests carried out by the applicant on components have surprisingly shown that even in the case of circumferential grooves with a rectangular cross-section, an adequate bead volume for fixing the valve housing in the valve receiver by positive engagement can flow into the circumferential grooves and get compressed therein.

### BRIEF DESCRIPTION OF THE DRAWINGS

Further features of the invention will result from the following description given with reference to the appended figures with partially schematic representations showing an exemplary embodiment of the invention with the help of which the inventive sealing effect is further elucidated. If not otherwise specified, identical or functionally identical features or components are identified by the same reference numerals. The figures show:

FIG. 1 is a partial section view of a hydraulic assembly comprising a valve carrier with a hydraulic valve fixed therein by a clinched connection;

FIG. 2 is a longitudinal section view of the hydraulic valve of FIG. 1;

FIG. 3 is an enlarged longitudinal section view of a clinched connection of the invention comprising rectangular circumferential grooves;

FIG. 4 is the detail Z of FIG. 3, in a further enlarged representation,

and, schematically represented in each case:

FIG. 5 is a diagram of the force conditions at the inventive clinched connection of FIG. 3, at −30° C.;

FIG. 6 is a diagram of the force conditions at the inventive clinched connection of FIG. 3, at 150° C.;

FIG. 7 is a diagram of the force conditions at an inventive clinched connection comprising trapezium-shaped circumferential grooves, at 150° C.;

FIG. 8 is a diagram of the force conditions for a prior art clinched connection, at 30° C., and

FIG. 9 is a diagram of the force conditions at the prior art clinched connection, at 150° C.

### DETAILED DESCRIPTION OF THE PREFERRED EMBODIMENTS

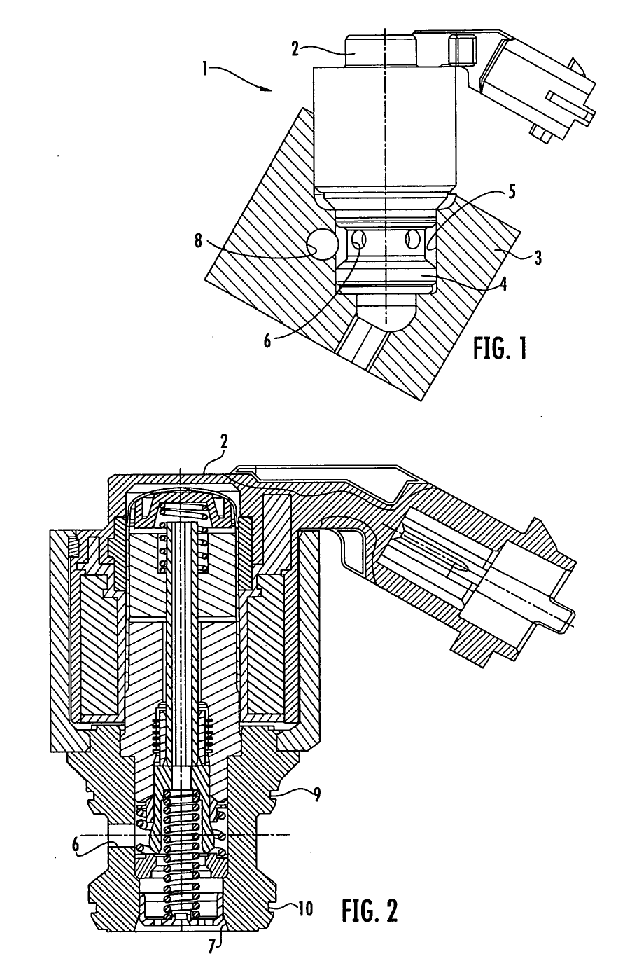

FIG. 1 discloses a hydraulic assembly 1 that is comprised of a hydraulic valve 2 and a valve carrier 3. The hydraulic valve 2 comprises a valve housing 4 made of a steel material and having a circular cross-section which is received in a cylindrical valve receiver 5 of the valve carrier 3, which, in the present case, is made entirely of an aluminum material and inseparably fixed through a clinched connection by positive engagement in the valve carrier 3. The hydraulic valve 2 represented in greater detail in FIG. 2 is an electrically controlled 2/2 directional switching valve of a type known, per se, which, together with the valve carrier 3 forms a part of a likewise known electrohydraulic valve control device of an internal combustion engine comprising variably operated gas exchange valves.

The first hydraulic connection 6 extends through the peripheral wall of the valve housing 4 and the second hydraulic connection 7 extends on a front end of the valve housing 4 on the bottom of the valve receiver 5. The hydraulic connection 6 is in hydraulic communication with a hydraulic channel 8 which is arranged in the valve carrier 3 and opens into the valve receiver 5 while extending between two circumferential grooves 9 and 10 which are required for realizing the clinched connection (for the sake of better perception, the circumferential grooves 9, 10 have been shown on an exaggeratedly large scale but in reality they have a distinctly smaller cross-section).

As already mentioned above, in the present context, the term clinched connection is to be understood as a plastic deformation of material of the valve carrier 3 which possesses a relatively low material strength. The material deformation is produced during the insertion of the valve housing 4, which acts as a calking die, into the valve receiver 5, and the displaced material of the valve carrier 3 flows into the circumferential grooves 9, 10 to get compressed therein.

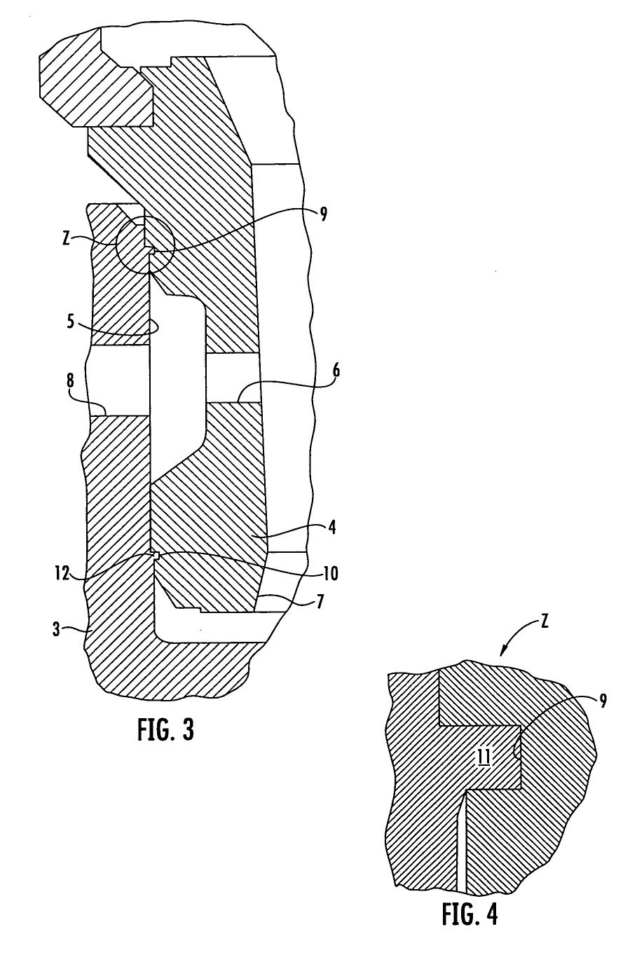

The finished clinched connection is disclosed in a simplified illustration in FIG. 3 and also as an enlarged detail Z in FIG. 4. The positive engagement realized through the beads 11 and 12 serves both for a durable fixing of the valve housing 4 in the valve carrier 3 and for hydraulic sealing of the hydraulic connection 6 in receiving direction of the valve housing 4, i.e. sealing from the surrounding of the valve carrier 3 and from the front-end hydraulic connection 7. The action of the valve housing 4 as a calking die requires certain design features with regard to the diameter and length ratios on the periphery of the valve housing 4 and the valve receiver 5, both of which have a stepped diameter. These design features are basically known from the prior art, so that there is no need to describe them further in the present context.

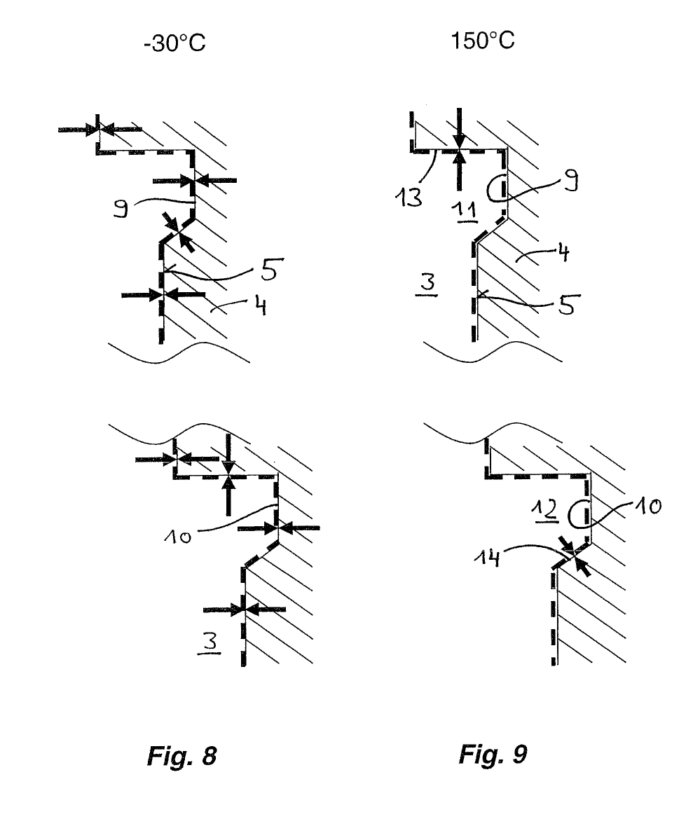

FIGS. 8 and 9 show, symbolized by double arrows, the contact forces decisive for the sealing effect in a hitherto usual clinched connection comprising the circumferential grooves 9, 10 arranged on both sides of the hydraulic connection 6, not shown, in a schematic representation, at two extreme operational temperatures of the assembly, i.e. at −30° C. and 150° C. In this prior art clinched connection, the valve housing 4 comprises chamfered circumferential grooves 9, 10 in which the plastically deformed material of the valve carrier 3 formed into beads 11, 12 is received.

At −30° C., the sealing effect of the clinched connection fabricated at an ambient temperature of about 20° C. is produced, both inside and outside of the circumferential grooves 9, 10, in the first place, by contact forces acting in a peripheral direction because, as a result of the different thermal expansion coefficients of aluminum material and steel material, the diameter of the valve receiver 5 contracts much more strongly than that of the valve housing 4.

But, as a result of the opposite relative expansion at 150° C., there exists the possibility of these contact forces being fully neutralized and, in the extreme case represented here, a circumferential gap can be formed between the valve receiver 5 and the valve housing 4. In this case, the sealing effect of the clinched connection can only be maintained through the contact forces acting in receiving direction of the valve housing 4 on the outer groove walls 13 and 14 of the circumferential grooves 9 and 10, respectively, oriented towards each other. These contact forces likewise result from the temperature-related relative expansion of the valve carrier 3 compared to the valve housing 4 in the receiving direction thereof. However, due to the inclination of the outer groove wall 14 in the receiving direction, the normal force acting on this groove wall 14 is substantially reduced, so that, as a result, the sealing effect relative to the bead 12 can be greatly impaired.

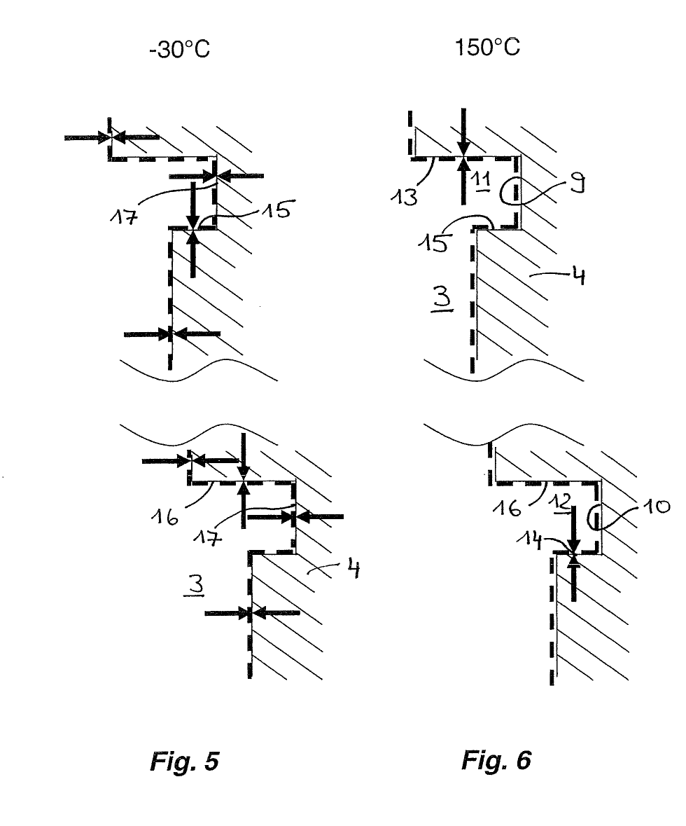

FIGS. 5 and 6 show a clinched connection of the present invention in an illustration corresponding to FIGS. 8 and 9. The modification made to the prior art clinched connection is cost-neutral but extremely efficient with regard to the sealing effect and concerns the geometric configuration of the circumferential grooves 9 and 10, i.e. not only the outer groove walls 13 and 14 but also the inner groove walls 15 and 16, which are turned away from each other, are all parallel to one another and perpendicular to the receiving direction of the valve housing 4. In conjunction with a cylindrical groove bottom 17, both the circumferential grooves 9 and 10 have a rectangular cross-section.

The sealing effect at −30° C., which remains excellent also in this modification, is additionally enhanced by the contact forces that act in receiving direction and with which the inner groove walls 15, 16 are loaded as a result of the temperature-related relative contraction of the valve carrier 3 compared to the valve housing 4. As elucidated above, a result of the opposed relative expansion at 150° C. can be that the sealing effect of the clinched connection can then be maintained only through the contact forces acting in receiving direction on the outer groove walls 13, 14. However, the inventive, modified shape of the circumferential grooves 9, 10 leads to substantially higher normal forces on the outer groove walls 13, 14 and, thus, to hydraulically adequate sealing contact pressures relative to the beads 11 and 12.

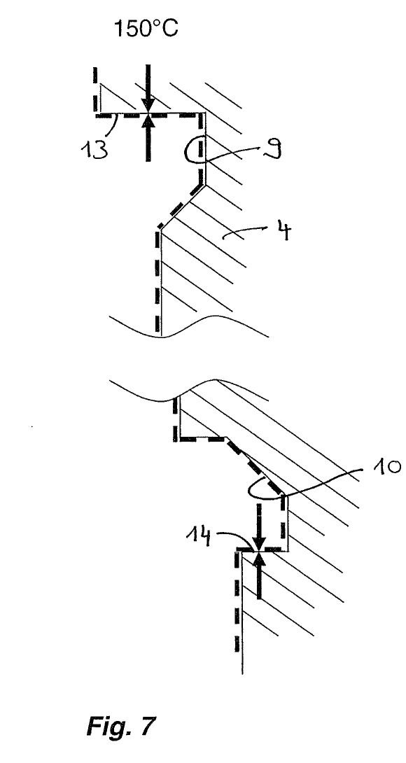

An alternative embodiment of a clinched connection is disclosed in FIG. 7, likewise showing contact forces at 150° C. In this embodiment, the modification of the prior art clinched connection is restricted substantially to the trapezium-shaped configuration of the circumferential groove 10 on the side of the second hydraulic connection 7. In this case, too, an essential inventive feature is that the circumferential grooves 9 and 10 comprise outer groove walls 13, 14 that are oriented towards each other and extend parallel to each other and perpendicularly to the receiving direction of the valve housing 4 in order to guarantee an adequate sealing effect of the clinched connection even at a high temperature.

### REFERENCE NUMERALS

1 Hydraulic assembly
2 Hydraulic valve
3 Valve carrier
4 Valve housing
5 Valve receiver
6 First hydraulic connection
7 Second hydraulic connection
8 Hydraulic channel
9 Circumferential groove
10 Circumferential groove
11 Bead
12 Bead
13 Outer groove wall
14 Outer groove wall
15 Inner groove wall
16 Inner groove wall
17 Groove bottom

1. A hydraulic assembly for an electrohydraulic valve control of an internal combustion engine, the assembly comprising a hydraulic valve including a valve housing and a valve carrier including a valve receiver in which the valve housing is received, the valve carrier possessing, at least in a region of the valve receiver, a distinctly lower material strength than the valve housing, the valve housing including a first circumferential groove and a second circumferential groove, the grooves being defined respectively by groove walls and extending on two sides of a hydraulic connection which extends through a peripheral wall of the valve housing and is in hydraulic communication with a hydraulic channel which is arranged in the valve carrier and opens into the valve receiver, a bead formed by a plastic deformation of material of the valve carrier being received in each of the first and the second grooves, so that, in a receiving direction of the valve housing, the groove walls and the beads not only fix the valve housing in the valve receiver by positive engagement but also cooperate with each other to hydraulically seal the valve housing, and outer ones of the groove walls of the circumferential grooves are oriented towards each other and extend parallel to each other and perpendicularly to the receiving direction of the valve housing.

2. A hydraulic assembly of claim 1, wherein inner ones of the groove walls of the circumferential grooves face away from each other and extend parallel to each other and perpendicularly to the receiving direction of the valve housing.

3. A hydraulic assembly of claim 2, wherein the circumferential grooves comprise a substantially rectangular cross-section.

4. A hydraulic valve for forming a hydraulic assembly comprising the hydraulic valve and a valve carrier, the hydraulic valve including a valve housing that can be fixed by positive engagement in a valve receiver of the valve carrier, the valve housing including a first circumferential groove and a second circumferential groove, the grooves being defined respectively by groove walls and extending on two sides of a hydraulic connection which extends through a peripheral wall of the valve housing, and each of the grooves being configured to receive a bead formed by a plastic deformation of material of the valve carrier, wherein outer ones of the groove walls of the circumferential grooves are oriented towards each other and extend parallel to each other and perpendicularly to a receiving direction of the valve housing.

5. A hydraulic valve of claim 4, wherein inner ones of the groove walls of the circumferential grooves face away from each other and extend parallel to each other and perpendicularly to the receiving direction of the valve housing.

6. A hydraulic valve of claim 5, wherein the circumferential grooves comprise a substantially rectangular cross-section.
